(19) United States
(12) Patent Application Publication
(10) Pub. No.: US 2007/0102912 A1
(43) Pub. Date: May 10, 2007

(54) Vehicle occupant protection apparatus having a plastic fill tube

(75) Inventor: Paul A. Bowers, Ray, MI (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Vehicle Safety Systems Inc.

(21) Appl. No.: 11/268,853

(22) Filed: Nov. 8, 2005

(51) Int. Cl. B60R 21/26; B60R 21/213

(52) U.S. Cl. 280/740; 280/730.2

(57) ABSTRACT

A vehicle occupant protection apparatus (10) includes an inflatable occupant protection device (14) and an inflation fluid source (12) that is actuatable to provide inflation fluid for inflating the inflatable occupant protection device (14). The vehicle occupant protection apparatus (10) also includes a conduit (34) for directing a flow of inflation fluid from the inflation fluid source (12) to the inflatable occupant protection device (14). The conduit (34) is formed from a flexible plastic material that enables the conduit (34) to be folded.

### TECHNICAL FIELD

The present invention relates to an inflatable vehicle occupant protection apparatus. More particularly, the present invention relates to an inflatable vehicle occupant protection apparatus having a plastic fill tube.

### BACKGROUND OF THE INVENTION

It is known to inflate an inflatable vehicle occupant protection device to help protect a vehicle occupant. One particular type of inflatable vehicle occupant protection device is an inflatable curtain. An inflatable curtain is inflatable away from the roof of the vehicle and into a position between a vehicle occupant and the side structure of the vehicle.

It is also known to use a fill tube to direct inflation fluid from an inflator to an inflatable curtain. A fill tube typically is an elongated, rigid conduit having a first end that is connected to a fluid outlet of the inflator and an opposite second end that is located in the inflatable curtain. Inflation fluid exiting the inflator passes through the fill tube and enters the inflatable curtain for inflating the inflatable curtain.

It is common for a fill tube to be manufactured at one location and shipped to another location for assembly into an inflatable vehicle occupant protection apparatus. Due to the elongated and rigid configuration of the fill tube, non-standard and thus more expensive shipping container may be required for the fill tubes. A fill tube that may be shipped using a standard, less expensive shipping container is desired.

### SUMMARY OF THE INVENTION

The present invention relates to a vehicle occupant protection apparatus comprising an inflatable occupant protection device and an inflation fluid source that is actuatable to provide inflation fluid for inflating the inflatable occupant protection device. The vehicle occupant protection apparatus also includes a conduit for directing a flow of inflation fluid from the inflation fluid source into the inflatable occupant protection device. The conduit is formed from a flexible plastic material. The flexible plastic material enables the conduit to be folded.

In accordance with another aspect, the present invention relates to a vehicle occupant protection apparatus comprising an inflatable occupant protection device and an inflation fluid source that is actuatable to provide inflation fluid for inflating the inflatable occupant protection device. The vehicle occupant protection apparatus also comprises a conduit for directing a flow of inflation fluid from the inflation fluid source into the inflatable occupant protection device. The conduit is formed from a flexible plastic material and has a deflated condition in which the conduit is substantially flat and an inflated condition in which the conduit has a predetermined shape. The conduit expands from the deflated condition to the inflated condition in response to receiving inflation fluid from the inflation fluid source.

### BRIEF DESCRIPTION OF THE DRAWINGS

The foregoing and other features of the present invention. will become apparent to those skilled in the art to which the present invention relates upon reading the following description with reference to the accompanying drawings, in which:

FIG. 1 illustrates a vehicle occupant protection apparatus constructed in accordance with the present invention;

FIG. 2 illustrates a portion of a fill tube of the vehicle occupant protection apparatus of FIG. 1, in a deflated condition;

FIG. 3 is a view taken along line 3-3 in FIG. 2;

FIG. 4 illustrates a portion of a fill tube of the vehicle occupant protection apparatus of FIG. 1, in an inflated condition;

FIG. 5 is a view taken along line 5-5 in FIG. 4;

FIG. 6 is a top view of a portion of the fill tube of the vehicle occupant protection apparatus of FIG. 1, in a deflated and partially folded condition; and

FIG. 7 is a schematic side view of a portion of the fill tube of the vehicle occupant protection apparatus of FIG. 1, in a deflated and folded condition.

### DETAILED DESCRIPTION OF THE INVENTION

FIG. 1 illustrates a vehicle occupant protection apparatus 10 constructed in accordance with the present invention. The vehicle occupant protection apparatus 10 includes an inflator 12 and an inflatable occupant protection device 14.

The inflator 12 is actuatable for providing inflation fluid for use in inflating the inflatable occupant protection device 14. The inflator 12 may include a stored quantity of pressurized inflation fluid and an ignitable material for heating the inflation fluid. Alternatively, the inflator 12 may include a combustible gas generating material, a stored quantity of pressurized inflation fluid, or any other source for providing inflation fluid.

The inflatable occupant protection device 14 of FIG. 1 is an inflatable curtain. Alternatively, the inflatable occupant protection device 14 may include an inflatable air bag, an inflatable seat belt, an inflatable knee bolster, an inflatable headliner, or a knee bolster operated by an inflatable air bag. The inflatable curtain 14 is preferably made from a flexible fabric material, such as woven nylon.

FIG. 1 illustrates the inflatable curtain 14 in a deflated and stored condition. In the deflated and stored condition, the inflatable curtain 14 is folded and stored within a housing 16. The inflatable curtain 14, in the deflated and stored condition, and the housing 16 have elongated configurations.

The housing 16 is made from a flexible fabric material. Tear seams (not shown) are formed in the housing 16. The tear seams are designed to tear during inflation of the inflatable curtain 14 to enable the inflatable curtain to exit the housing 16. The housing 16 is mounted to a vehicle 18 in a location adjacent both the side structure of the vehicle and a roof 20 of the vehicle. The side structure of the vehicle 18 illustrated in FIG. 1 includes an A-pillar 22, a B-pillar 24, a C-pillar 26, and side windows 28 and 30. FIG. 1 shows four mounting brackets 32 for securing the housing 16 to the side structure of the vehicle 18.

The vehicle occupant protection apparatus 10 also includes a fill tube 34 that forms an inflation fluid conduit between the inflator 12 and the inflatable curtain 14. The fill tube 34 extends from an outlet of the inflator 12 and into the inflatable curtain 14. In the embodiment illustrated in FIG. 1, the fill tube 34 has a length that is approximately equal to the length of the inflatable curtain 14. Also, in the embodiment illustrated in FIG. 1, the fill tube 34 extends longitudinally through approximately ninety percent of the inflatable curtain 14.

The fill tube 34 is formed from an impervious, flexible plastic material, such as polyvinylchloride sheeting or polyethylene. Alternatively, the fill tube 34 may be formed from a fabric that is coated with a plastic material, such as polyvinylchloride sheeting or polyethylene. As is best shown in FIG. 5, the fill tube 34 has a generally cylindrical wall portion 38 that is centered on an axis A. The wall portion 38 includes inner and outer surfaces 40 and 42, respectively. The inner surface 40 of the wall portion 38 defines an interior space 44 of the fill tube 34. Multiple through-holes 46 (FIG. 4) extend through the wall portion 38.

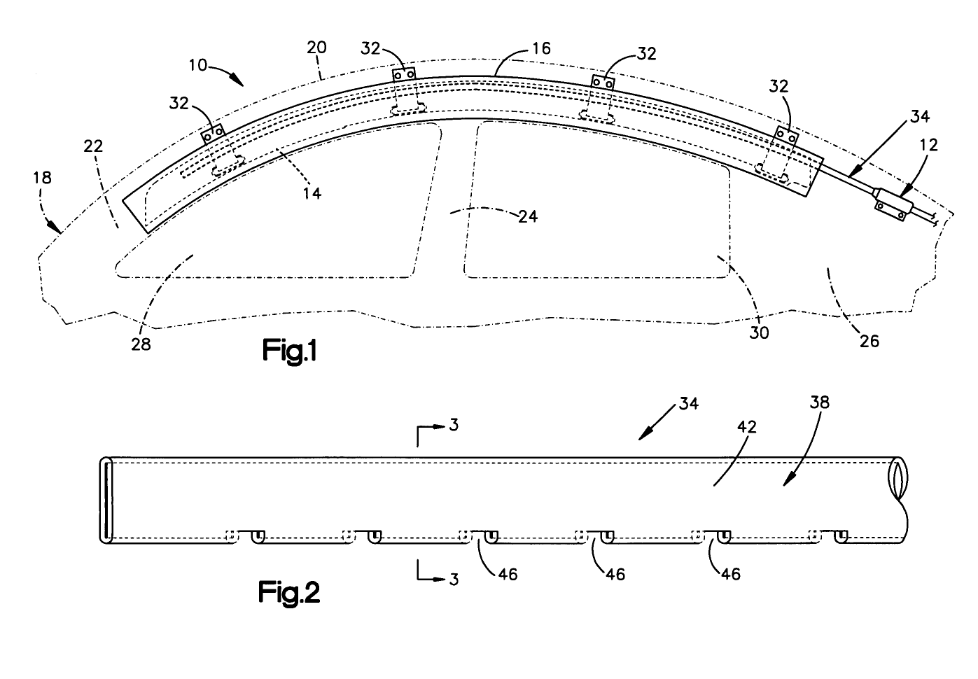

The fill tube 34 has a deflated condition and an inflated condition. FIG. 2 illustrates a portion of the fill tube 34 in the deflated condition. FIG. 4 illustrates the same portion of the fill tube 34 in an inflated condition.

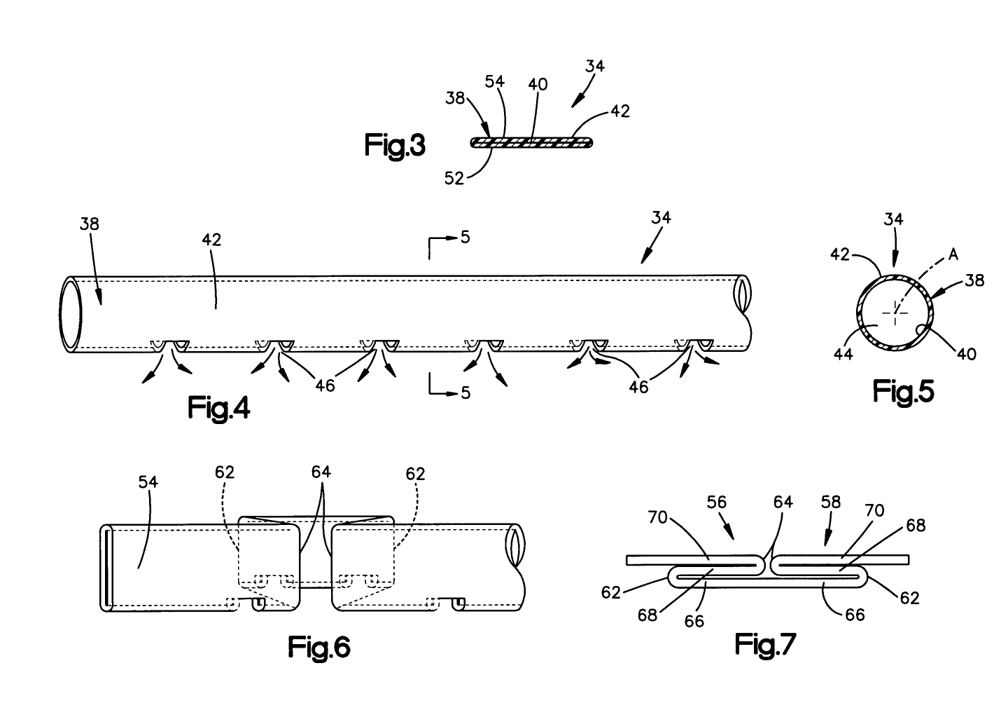

The fill tube 34 will assume the deflated condition when the fluid pressure within the interior space 44 and acting on the inner surface 40 of the wall portion 38 is less than the pressure acting on the outer surface 42 of the wall portion. The higher pressure acting on the outer surface 42 of the wall portion 38 forces fluid out of the interior space 44 through the through-holes 46. As the fluid is forced out of the interior space 44, the fill tube 34 flattens. When the fill tube 34 flattens, the inner surface 40 of the wall portion 38 collapses on itself so that a first half of the inner surface overlies a second half of the inner surface, as is shown in FIG. 3. The fill tube 34, when in the deflated condition, has the generally flat configuration shown in FIGS. 2 and 3. Also, when the fill tube 34 is in the deflated condition, the volume of the interior space 44 is substantially eliminated.

As shown in FIG. 3, when the fill tube 34 is in the deflated condition, the fill tube 34 includes lower and upper surfaces 52 and 54, respectively. The fill tube 34, when in the deflated condition, may be folded upon itself, as is illustrated with reference to FIGS. 6 and 7.

FIG. 6 illustrates a portion of the fill tube 34 in a deflated and partially folded condition. In FIG. 6, the portion of the fill tube 34 is being folded in a longitudinal direction to form two adjacent Z-folds 56 and 58 (FIG. 7), respectively. To form the Z-folds 56 and 58, the deflated fill tube 34 is folded along a first fold line 62 so that a first portion of the upper surface 54 overlies an adjacent, second portion of the upper surface 54. The deflated fill tube 34 is then folded along a second fold line 64 so that a first portion of the lower surface 52 overlies an adjacent, second portion of the upper surface 52. Each Z-fold 56 and 58 results in a stack that includes a lower layer 66, an intermediate layer 68, and an upper layer 70. The lower, intermediate, and upper layers 66, 68, and 70 are each formed from adjacent portions of the deflated fill tube 34.

The deflated fill tube 34 may also be rolled or compacted in another matter, other than by folding. When compacted, such as by folding, the deflated fill tube 34 may be shipped using a standard shipping container that has a cost lower than those generally required for fill tubes that may not be compacted.

The fill tube 34 is assembled into the vehicle occupant protection apparatus 10 in an unfolded and deflated condition. The fill tube 34 remains in the deflated condition until the inflator of the vehicle occupant protection apparatus 10 is actuated and inflation fluid enters the interior space 44. Inflation fluid entering the interior space 44 results in increased pressure acting on the inner surface 40 of the wall portion 38. When the pressure acting on the inner surface 40 of the wall portion 38 becomes greater than the pressure acting on the outer surface 42 of the wall portion, the fill tube 34 expands into the inflated condition, shown in FIGS. 4 and 5.

When the fill tube 34 is in the inflated condition, the volume of the interior space 44 reaches substantially the maximum volume possible, based on the original cross-sectional shape of the fill tube. The fill tube 34 forms a conduit between the inflator 12 and the inflatable curtain 14. Inflation fluid exiting the inflator 12 passes through the interior space 44 of the fill tube 34. The inflation fluid then exits the fill tube 34 via the through-holes 46 and enters the inflatable curtain 14. The inflatable curtain 14, in response to receiving the inflation fluid, inflates to cover some or all of the side structures 22, 24, 26, 28, and 30 of the vehicle 18.

From the above description of the invention, those skilled in the art will perceive improvements, changes and modifications. Such improvements, changes and modifications within the skill of the art are intended to be covered by the appended claims.

Having described the invention, I claim the following:

1. A vehicle occupant protection apparatus comprising:
an inflatable occupant protection device;
an inflation fluid source that is actuatable to provide inflation fluid for inflating the inflatable occupant protection device; and
a conduit for directing a flow of inflation fluid from the inflation fluid source into the inflatable occupant protection device, the conduit being formed from a flexible plastic material, the flexible plastic material enabling the conduit to be folded.

2. The vehicle occupant protection apparatus of claim 1 wherein the conduit has a deflated condition and an inflated condition, the conduit, when in the deflated condition, being substantially flat and, when in the inflated condition, having a predetermined shape, the conduit expanding from the deflated condition to the inflated condition in response to receiving inflation fluid from the inflation fluid source.

3. The vehicle occupant protection apparatus of claim 2 wherein the conduit is foldable when in the deflated condition.

4. The vehicle occupant protection apparatus of claim 3 wherein the conduit, when folded, includes at least one Z-fold that includes a stack of layers of the conduit.

5. The vehicle occupant protection apparatus of claim 2 wherein the conduit includes a wall portion that defines an interior space through which inflation fluid flows, the interior space having a volume that is substantially eliminated when the conduit is in the deflated condition and that is substantially maximized when the conduit is in the inflated condition.

6. The vehicle occupant protection apparatus of claim 1 wherein the flexible plastic material is polyvinylchloride or polyethylene.

7. The vehicle occupant protection apparatus of claim 1 wherein the inflatable occupant protection device is a side curtain that is inflatable for covering side structure of the vehicle.

8. A vehicle occupant protection apparatus comprising:
an inflatable occupant protection device;
an inflation fluid source that is actuatable to provide inflation fluid for inflating the inflatable occupant protection device; and
a conduit for directing a flow of inflation fluid from the inflation fluid source into the inflatable occupant protection device, the conduit being formed from a flexible plastic material and having a deflated condition in which the conduit is substantially flat and an inflated condition in which the conduit has a predetermined shape, the conduit expanding from the deflated condition to the inflated condition in response to receiving inflation fluid from the inflation fluid source.

9. The vehicle occupant protection apparatus of claim 8 wherein the conduit is foldable when in the deflated condition.

10. The vehicle occupant protection apparatus of claim 9 wherein the conduit, when folded, includes at least one Z-fold that includes a stack of layers of the conduit.

11. The vehicle occupant protection apparatus of claim 8 wherein the conduit includes a wall portion that defines an interior space through which inflation fluid flows, the interior space having a volume that is substantially eliminated when the conduit is in the deflated condition and that is substantially maximized when the conduit is in the inflated condition.

12. The vehicle occupant protection apparatus of claim 8 wherein the flexible plastic material is polyvinylchloride or polyethylene.

13. The vehicle occupant protection apparatus of claim 8 wherein the inflatable occupant protection device is a side curtain that is inflatable for covering side structure of the vehicle.
